(19) United States
(12) Patent Application Publication
(10) Pub. No.: US 2026/0369464 A1
(43) Pub. Date: Nov. 19, 2026

(54) HIGH CURRENT TRANS-INDUCTOR

(71) Applicant: Eaton Intelligent Power Limited, Dublin (IE)

(72) Inventors: Zhuo Min Liu, Dublin, CA (US); Jianshun Zhang, Huinan (CN); Zhihui Yang, Shanghai (CN)

(73) Assignee: Eaton Intelligent Power Limited, Dublin (IE)

(21) Appl. No.: 19/665,335

(22) Filed: May 1, 2026

Related U.S. Application Data
(60) Provisional application No. 63/805,839, filed on May 14, 2025.

(51) Int. Cl. H01F 27/30; H01F 27/255; H01F 27/28; H01F 27/29

(52) U.S. Cl. CPC H01F 27/306; H01F 27/255; H01F 27/2852; H01F 27/292; H01F 2027/2861

(57) ABSTRACT

A surface mount electromagnetic component for multi-phase electrical power circuitry implemented on a circuit board includes a single-piece magnetic core structure, and a winding assembly for each phase. Each winding assembly includes an inner winding and an outer winding. The inner winding is electrically isolated from the outer winding, the inner winding defines a first inverted U-shaped main winding portion, the first inverted U-shaped main winding portion includes a first top section and first vertical legs perpendicular to the first top section; and the outer winding defines a second inverted U-shaped main winding portion, the second inverted U-shaped main winding portion includes a second top section and second vertical legs perpendicular to the second top section.

### CROSS-REFERENCE TO RELATED APPLICATION

This application claims the benefit of U.S. Provisional Application No. 63/805,839, filed on May 14, 2025 and titled HIGH CURRENT TRANS-INDUCTOR, which is incorporated herein by reference in its entirety.

### TECHNICAL FIELD

This disclosure relates to electrical components, for example, trans-inductors.

### BACKGROUND

An inductor, also called a coil, choke, or reactor, is a passive two-terminal electrical component that stores energy in a magnetic field when electric current flows through it. An inductor typically consists of an insulated wire wound into a coil. Trans-inductor voltage regulators (TLVRs) allow engineers to improve on the transient response of their voltage regulator modules (VRMs) and meet the demanding load requirements of CPU, FPGAs, and ASICs in current and bandwidth without hurting other critical parameters. For engineers looking to rapidly implement a TLVR prototype, the single-secondary TLVR topology involves minimal risk given that the footprint of the TLVR inductors match with the standard single-turn inductor. This topology enables engineers to meet changing system requirements without sacrificing on cost, board space, and manufacturability.

With the increasing power level requirement for data centers, a new multiphase DC/DC voltage regulator using trans-inductor was released in the technical disclosure commons domain in 2019, and this new multiphase voltage regulator architecture has been adapting to the computing industry rapidly. The multiphase trans-inductor voltage regulator (TLVR) is an alternative circuit topology where the inductors in each of the phases becomes the primary winding of a transformer and the secondary winding is connected in a series loop with an additional compensation inductor (LC). This results in a fast transient response that matches the demands of the load in amperage and bandwidth without sacrificing any other critical parameters (for example, board space, cost, efficiency, power density, etc.). The TLVR architecture allows end-users to benefit from the advantages of phase coupling, resulting in an extremely fast transient response that scales to the demands of the load in amps and bandwidth.

### SUMMARY

Traditional trans-inductor regulators use two core pieces that surround the inner and outer windings. These core pieces are typically made of ferrite material, which is easier to manufacture and assemble when there is a physical separation between the two halves of the core. As a result, conventional trans-inductors are designed with two-piece cores made out of ferrite material. However, this design presents two major drawbacks. The first is with respect to performance. Ferrite material has a relatively low magnetic saturation threshold, which necessitates a larger core footprint to handle the desired current levels. Having two core halves also increases manufacturing complexity. Assembling the four components (two cores and two windings) requires multiple precise steps. Common failure modes such as misalignment of the core halves, incomplete core joining, and high-potential test failures often occur due to the complexity and precision required in assembly. As a result, the manufacturing yield for traditional trans-inductors is low.

To address the foregoing issues, implementations described herein introduce a single-piece core for the trans-inductor. This core may be formed from a metal powder material, resulting in a less densely packed core structure compared to a core formed of a solid, non-fragmented material. Unlike ferrite, which generally requires a split-core design, the metal powder material allows for a robust, functional single-piece structure. This single-piece core offers improved magnetic saturation capability and more stable magnetic permeability compared to traditional two-piece ferrite cores. Additionally, the single-piece design simplifies assembly, particularly for multi-phase versions, by eliminating the need for precise alignment between core halves. During assembly, the two wires are simply inserted through the top opening of the single-piece core, and one or both pairs of wire ends are bent to form the terminals. Additionally, unlike traditional two-piece cores that require epoxy to hold them together, the single-piece core does not require adhesives, further streamlining the manufacturing process.

In one aspect, a surface mount electromagnetic component for multi-phase electrical power circuitry implemented on a circuit board includes a single-piece magnetic core structure, and a winding assembly for each phase. Each winding assembly includes an inner winding and an outer winding. The inner winding is electrically isolated from the outer winding, the inner winding defines a first inverted U-shaped main winding portion, the first inverted U-shaped main winding portion includes a first top section and first vertical legs perpendicular to the first top section; and the outer winding defines a second inverted U-shaped main winding portion, the second inverted U-shaped main winding portion includes a second top section and second vertical legs perpendicular to the second top section.

Implementations may include one or more of the following features.

The single-piece magnetic core structure may be made from metal powder material.

The single-piece magnetic core structure may be made from ferrite material.

In another aspect, an electromagnetic component includes: a single-piece magnetic core structure; one or more winding assemblies, each winding assembly configured to be received in a respective open space in the single-piece magnetic core structure, and each winding assembly including: a first electrically conductive winding; and a second electrically conductive winding. The second electrically conductive winding is electrically isolated from the first electrically conductive winding and is configured to be magnetically coupled to the first electrically conductive winding. Each winding assembly is electrically isolated from any other winding assembly.

Implementations may include one or more of the following features.

The single-piece magnetic core structure may be made of a particulate magnetic material.

Each of the first and second electrically conductive windings of each winding assembly may include a top portion and first and second leg portions that extend from the top portion. Ends of each of the first and second leg portions of the first and second electrically conductive windings may extend to an exterior of the single-piece magnetic core structure. An end of one or more of the first and second leg portions of the first and second electrically conductive windings may be bent into terminal pads.

In some implementations, in each winding assembly, the second electrically conductive winding is at least partially surrounded by the first electrically conductive winding.

In some implementations, in each winding assembly, the second electrically conductive winding and the first electrically conductive winding are arranged such that the winding assembly is asymmetrical in at least one dimension.

In some implementations, in each winding assembly, the second electrically conductive winding and the first electrically conductive winding are arranged such that the winding assembly has mirror symmetry in at least two dimensions.

Each winding assembly also may include an electrically insulating material between the first electrically conductive winding and the second electrically conductive winding.

In some implementations, in each winding assembly, the electrically insulating material holds the first electrically conductive winding and the second electrically conductive winding in a fixed spatial relationship.

The single-piece magnetic core structure also may include a sidewall structure extending between a top portion and a bottom portion, the top portion defining an open space for each of the one or more winding assemblies, and the bottom portion defines two openings for each of the one or more winding assemblies. The sidewall structure may include four sidewalls, each sidewall perpendicular to two other sidewalls and parallel to one other sidewall, and two of the four sidewalls may define at least one recessed region near the bottom portion.

The single-piece magnetic core structure also may include a sidewall structure extending between a top portion and a bottom portion, the top portion may define an opening to a respective open space, and the bottom portion may define openings to a respective open space.

Each winding assembly may be pre-formed separately from the single-piece magnetic core structure.

In another aspect, an assembly includes: a first electrically conductive winding including a first top portion and two first legs extending from the first top portion; a second electrically conductive winding including a second top portion and two second legs extending from the second top portion, and an electrically insulating material between the first and second electrically conductive windings. The second electrically conductive winding is electrically isolated from the first electrically conductive winding and is configured to be magnetically coupled to the first electrically conductive winding, the electrically insulating material holds the first and second electrically conductive windings in a fixed spatial relationship, and the assembly is pre-prepared and configured for insertion into an opening in a single-piece magnetic core.

In another aspect, a method of assembling an electromagnetic component for multi-phase electrical power circuitry includes: providing a single-piece magnetic core including a center post and a top portion that defines one or more open regions, each open region associated with one phase and leading to a respective open space in the single-piece magnetic core, each open space including an open region above the center post and though holes on at least two sides of the center post; providing one or more pre-formed winding assemblies, each winding assembly associated with one phase and including first and second U-shaped electrically conductive windings that are electrically isolated from each other and held in a fixed spatial relationship; and assembling the electromagnetic component for multi-phase electrical power circuitry by inserting each of the pre-formed winding assemblies into a respective one of the one or more open regions with legs of the first and second U-shaped electrically conductive windings extending to the exterior of the single-piece magnetic core.

Implementations may include one or more of the following features.

Assembling the electromagnetic component for multi-phase electrical power circuitry further may include bending an end of one or more of the first and second U-shaped electrically conductive winding to form a terminal pad.

The method also may include electrically connecting the each of the first and second U-shaped electrically conductive windings to one or more traces on a printed circuit board.

Implementations of any of the techniques described herein may include a system, a device, a process, or an electromagnetic component, just to name a few. The details of one or more implementations are set forth in the accompanying drawings and the description below. Other features will be apparent from the description and drawings, and from the claims.

### BRIEF DESCRIPTION OF THE DRAWINGS

FIG. 1A illustrates a perspective view of an example single-piece core trans-inductor.

FIG. 1B illustrates a cross-sectional view of the example single-piece core trans-inductor in FIG. 1A.

FIG. 1C illustrates a top view of the example single-piece core trans-inductor in FIG. 1A.

FIG. 1D is a cross-sectional view of the magnetic core of FIG. 1C in the X-Y plane taken along the line A—A of FIG. 1C.

FIG. 2A illustrates a perspective view of an example single-piece core trans-inductor before bending the extruded winding terminals.

FIG. 2B illustrates a bottom view of the example single-piece core trans-inductor in FIG. 2A.

FIG. 2C illustrates a cross-sectional view of the example single-piece core trans-inductor in FIG. 2A.

FIG. 3A illustrates a perspective view of an example single-piece core.

FIG. 3B illustrates a cross-sectional view of the example single-piece core trans-inductor in FIG. 3A.

FIG. 3C illustrates a top view of the example single-piece core trans-inductor in FIG. 3A.

FIG. 4A illustrates an exploded view of an example configuration with both inner and outer windings bent.

FIGS. 4B and 4C illustrate the assembly process for the configuration shown in FIG. 4A.

FIG. 5A illustrates a perspective view of another example configuration with only the inner winding bent.

FIG. 5B illustrates a cross-sectional view of the example configuration in FIG. 5A.

FIG. 5C illustrates a top view of the example configuration in FIG. 5A.

FIG. 6A illustrates an exploded view of another single-piece core trans-inducer.

FIGS. 6B and 6C illustrate the assembly process for the configuration shown in FIG. 6A.

FIG. 7A illustrates a perspective view of another example configuration of a single-piece core trans-inducer.

FIG. 7B illustrates a bottom view of the example configuration in FIG. 7A.

FIG. 8A illustrates a perspective view of an example of a two-phase single-piece core.

FIG. 8B illustrates a cross-sectional view of the example two phase single-piece core in FIG. 8A.

FIG. 8C illustrates another cross-sectional view of the example two phase single-piece core in FIG. 8A.

FIG. 8D illustrates a bottom view of the example two phase single-piece core in FIG. 8A.

FIG. 8E illustrates a top view of the example two phase single-piece core in FIG. 8A.

FIG. 9A is a perspective view of a system that includes the trans-inductor of FIG. 4C.

FIG. 9B is a side view of the system of FIG. 9A.

### DESCRIPTION

Traditional trans-inductor architecture may include two magnetic cores (core halves) and two windings including one primary winding and one secondary winding. The two magnetic cores may include two substantially E-shaped halves. The two windings may include an inner winding and an outer winding. The inner winding may be coupled to the center post of the E-shaped core, and the outer winding may be coupled to the inner winding. The inner winding is electrically isolated from the outer winding. Ferrite material is typically used to make such two core halves. Ferrite material has a relatively low saturation capability which results in the core made of two core halves having a relatively larger footprint. Manufacturing a conventional trans-inductor typically includes assembling the inner winding to one core halve, assembling and aligning the outer winding to the inner winding, and assembling another core halve to the winding to form the trans-inductor. Assembling these components takes many steps and requires precision. Failures such as misalignment of the two core halves, separation of the core halves, and hi-pot failure, a may occur because of the many steps of assembly and many times of alignment. The manufacturing yield rate for a traditional trans-inductor can be low. Further, traditional trans-inductors have limitations in handling high currents due to low saturation magnetic flux density.

To addresses these limitations of traditional trans-inductors, this disclosure introduces a single-piece core trans-inductor with a single-piece core made from metal powder material such as alloy powder magnetic material. The disclosed single-piece core trans-inductor has improved permeability and efficiency as compared to a traditional trans-inductor made by assembly more than one core portion of ferrite. The single-piece core trans-inductor can be particularly suited for high-power applications such as data centers and artificial intelligence (AI) systems, where high current handling and compact size are critical.

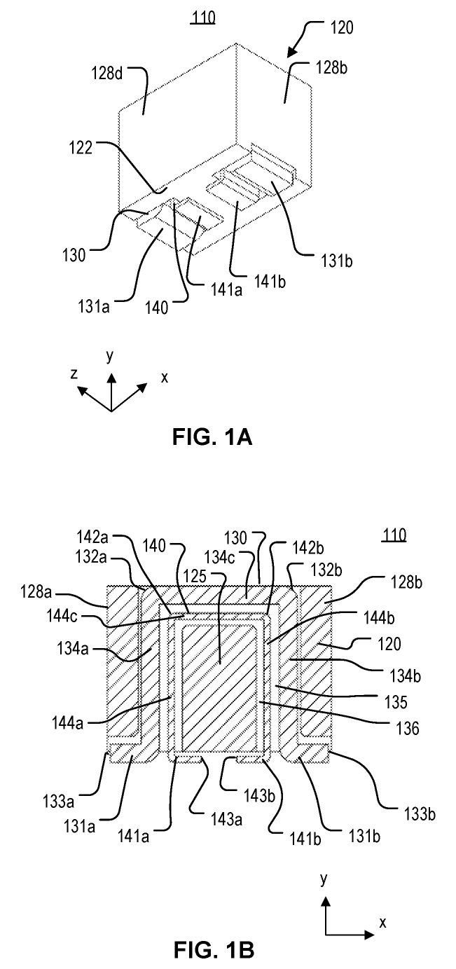

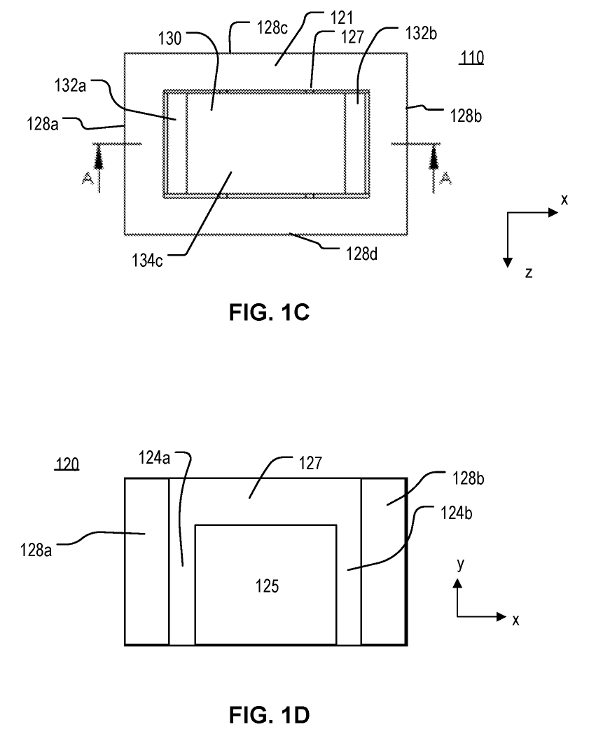

FIG. 1A is a perspective view of an example single-piece core trans-inductor 110. FIG. 1B is a cross-sectional view of the example single-piece core trans-inductor 110. FIG. 1C is a top view of the example single-piece core trans-inductor 110. The single-piece core trans-inductor 110 includes a magnetic core 120 and two windings: an outer winding 130 and an inner winding 140. The magnetic core 120 is a single-piece element and is not made by joining two pre-formed halves into a larger core.

The magnetic core 120 has sides 128a, 128b, 128c, and 128d that extend from a bottom region 122 to a top region 121. The sides 128a and 128b are parallel to each other and the sides 128c and 128d are parallel to each other. The sides 128a and 128b are perpendicular to the sides 128c and 128d. The top region 121 and the bottom region 122 are in parallel planes and are perpendicular to the sides 128a, 128b, 128c, 128d. The sides 128a, 128b, 128c, 128d, the bottom region 122, and the top region 121 are planar. The top region 121 defines an open region 127 (also referred to as a hollow cut).

Referring also to FIG. 1D, which is a cross-sectional view of the magnetic core 120 in the X-Y plane taken along the line A—A of FIG. 1C, the magnetic core 120 includes a center post 125 that is an integral part of the core 120. For example, the center post 125 may extend from one of the sides 128a, 128b, 128c, 128d or between the sides 128c and 128d. The center post 125 has a smaller extent than the core 120 such that the interior of the core 120 includes an open space to receive the windings 130 and 140. As shown in FIG. 1D, the open space includes the open region 127 and two through holes 124a and 124b on either side of the center post 125. In the example shown, the cross section of the magnetic core 120 is substantially E-shaped.

Each of the inner winding 140 and the outer winding 130 is an electrically conductive material and the magnetic core 120 is a magnetic material. A time-varying or alternating (AC) electrical current that flows in the inner winding 140 generates a magnetic field that induces a current in the outer winding 130. Similarly, an AC electrical current flowing in the outer winding 130 generates a magnetic field that induces a current in the inner winding 140. The core 120 and the center post 125 are made of a magnetic material that directs the magnetic field between the windings 130 and 140. Thus, the windings 130 and 140 can be magnetically coupled and can induce current in each other. However, the inner winding 140 and the outer winding 130 are electrically isolated from each other and are separated from each other by a gap 135. There is no direct physical contact between the windings 130 and 140 and current does not flow directly from the winding 130 to the winding 140 or vice versa. For example, an electrically insulating material such as plastic may fill the gap 135 between the inner winding 140 and the outer winding 130.

The inner winding 140 and the outer winding 130 are positioned in the open space of the core 120, with the inner winding 140 between the center post 125 and the outer winding 130. The inner winding 140 partially surrounds the center post 125. The inner winding 140 and the center post 125 may be separated by a gap 136. In the example shown in FIG. 1B, the inner winding 140 is U-shaped and includes side portions 144a and 144b and a top portion 144c that extends between the side portions 144a and 144b. The top portion 144c is connected to the side portions 144a and 144b at a respective beveled or curved interface 142a and 142b. Each side portion 144a, 144b is received in a respective through hole 124a, 124b and the top portion 144c is in the open region 127. The side portions 144a, 144b extend to respective ends 143a, 143b. Each end 143a, 143b extends through the respective through hole 124a, 124b to the exterior of the core 120.

The outer winding 130 is also a U-shaped winding and includes side portions 134a and 134b and a top portion 134c that extends between the side portions 134a and 134b. The top portion 134c is connected to the side portions 134a and 134b at respective curved or beveled interfaces 132a and 132b. Each side portion 134a and 134b is in a respective through hole 124a, 124b and the top portion 134c is in the open region 127. Each end 133a, 133b extends through the respective through hole 124a, 124b to the exterior of the core 120.

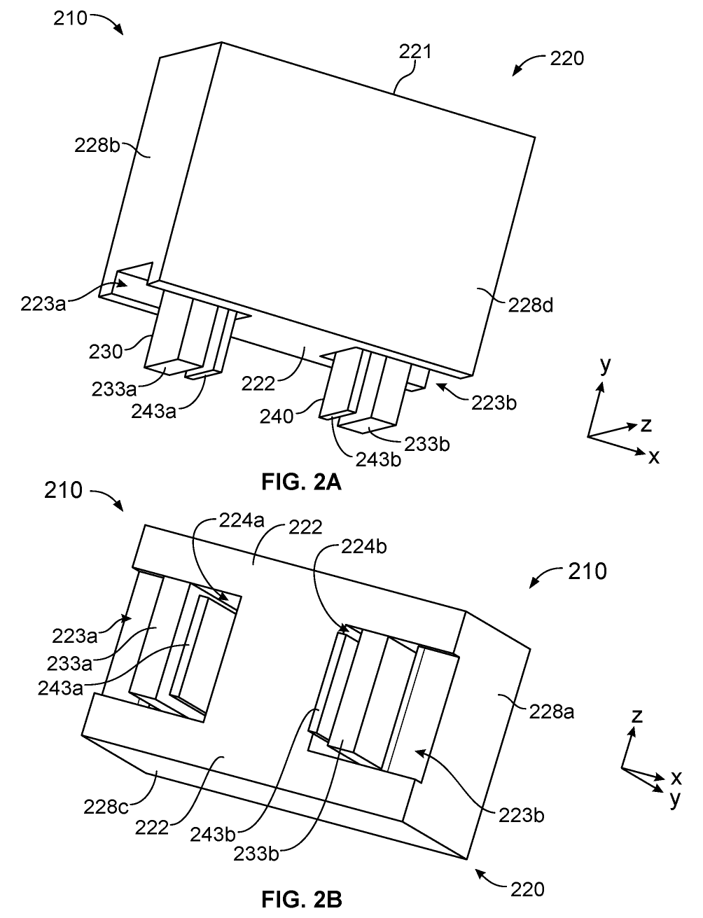

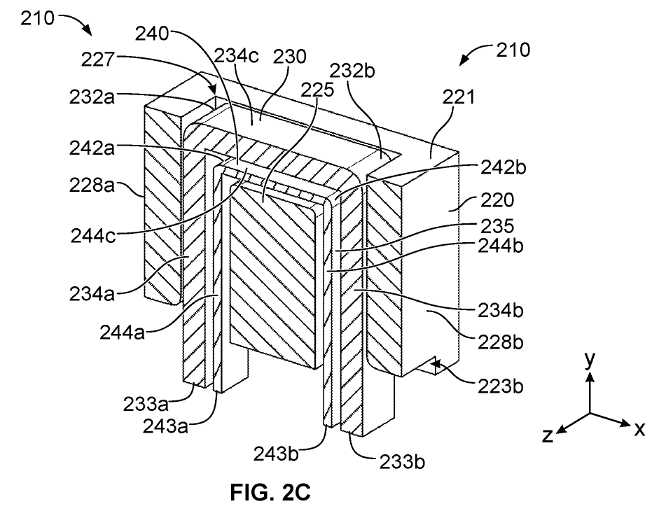

Each of the inner winding 140 and the outer winding 130 may formed by folding or bending a sheet or bar of electrically conductive material into the U-shaped windings shown in FIG. 1B. Additionally, ends 143a and 143b of the inner winding 140 may be bent toward each other to form terminal pads 141a and 141b. Similarly, ends 133a and 133b of the outer winding 130 may be bent away from each other to form terminal pads 131a and 131b. In the example shown, all the terminal pads 141a, 141b, 131a, and 131b are substantially coplanar, which may facilitate electrical connection of the pads to a flat printed circuit board (PCB). However, other implementations are possible and the terminal pads 141a, 141b, 131a, and 131b are not necessarily coplanar. Bending the ends 133a, 133b and 143a, 143b to form the terminal pads 131a, 131b and 141a, 141b increases the size of the electrical connection between the winding and the PCB, thereby lowering the contact resistance of the connection point. The reduction in contact resistance can, for example, reduce heat generation and losses and improve performance in applications that carry high currents (for example 50 amperes (A) or greater). However, the inner winding 140 and the outer winding 130 may lack their respective terminal pads 141a, 141b and 131a, 131b. In these implementations, the ends 133a, 133b and 143a, 143b are electrically connected to the PCB. For example, FIGS. 2A-2C show an implementation without the terminal pads.

Manufacturing the disclosed trans-inductor 110 may include inserting the two U-shaped windings 130 and 140 into the through holes 124a and 124b of the single-piece core 120 and bending the ends 133a, 133b to form the terminal pads 131a, 131b and bending the ends 143a, 143b to form the terminal pads 141a, 141b.

FIGS. 2A-2C relate to another example of a single-piece core trans-inductor 210. FIG. 2A is a perspective view of the single-piece core trans-inductor 210. FIG. 2B is a bottom view of the example single-piece core trans-inductor 210. FIG. 2C is a cross-sectional view of the example single-piece core trans-inductor 210.

The trans-inductor 210 includes a single-piece magnetic core 220, an inner winding 240, and an outer winding 230. The magnetic core 220 includes sides 228a, 228b, 228c, 228d; a bottom region 222, and a top region 221. Each side 228a and 228b defines a respective recessed area 223a and 223b near the bottom region 222. Referring to FIG. 2C, the single-piece core 220 includes a central post 225. The top region 221 defines an open region 227 and through holes 224a and 224b extend through the core 220 on either side of the central post 225. Together, the open region 227 and the through holes 224a and 224b define a substantially U-shaped open space in the interior of the core 220.

The inner winding 240 and the outer winding 230 are electrically conductive sheets or bars that are formed into the U-shaped elements shown in FIG. 2C. The windings 240 and 230 may be made of any electrically conductive material. For example, the windings 240 and 230 may be copper. The portions of the windings 240 and 230 that are bent are curved and do not have sharp edges or corners. For example, the outer winding 230 includes curved interface portions 232a and 232b and the inner winding 240 includes curved interface portions 242a and 242b. The inner winding 240 includes side portions 244a and 244b and a top portion 244c that extends between the side portions 244a and 244b. The outer winding 230 includes side portions 234a and 234b and a top portion 234c that extends between the side portions 234a and 234b.

The inner winding 240 and the outer winding 230 are received in the U-shaped open space in the interior of the core 220, with the inner winding 240 between the central post 225 and the outer winding 230. The inner winding 240 and the outer winding 230 are separated by a gap 235 and are electrically isolated from each other. For example, the gap 235 may be filled with an electrically insulating material.

The inner winding 240 is partially surrounded by the outer winding 230. In the example shown, the windings 240 and 230 are aligned. For example, the spatial center of each winding 230 and 240 may overlap or coincide. In some implementations, the inner winding 240 and the outer winding 230 are nested. Additionally, the windings 230 and 240 may have the same extent along the Z axis and may be positioned such that the front and/or back sides of the windings are co-planar. In some implementations, the outer winding 230 has a greater extent along the Z axis than the inner winding 240. The assembly of the outer winding 230 and the inner winding 240 may have mirror symmetry about X axis or may be asymmetrical about the X axis. In some implementations, the spatial center of the inner winding 240 and the spatial center of the outer winding 230 do not overlap. Moreover, although the inner winding 240 is depicted as being partially surrounded by the outer winding 230, other implementations are possible. For example, the inner winding 240 and the outer winding 230 may be displaced in the Z direction such that the windings have a side-by-side or laterally spaced relationship.

The inner winding 240 includes ends 243a and 243b, and the outer winding 230 includes ends 233a and 233b. The ends 243a, 243b and the ends 233a, 233b extend from the through holes 224a and 224b, respectively. The windings 230 and 240 lack pads. To electrically connect the winding 230 to trace(s) on a PCB, the ends 233a, 233b are electrically connected to the trace(s). To electrically connect the winding 240 to other trace(s) on the PCB, the ends 243a, 243b are connected to those other trace(s).

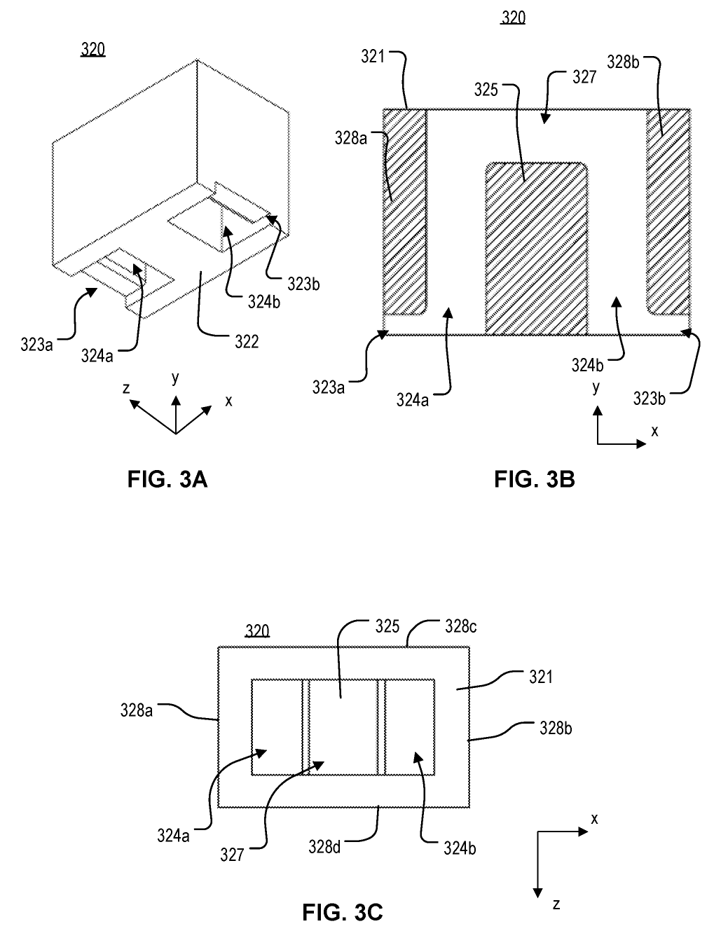

FIG. 3A is a perspective view of another example of a single-piece magnetic core 320. The single-piece magnetic core 320 may be used in a trans-inductor. For example, the core 320 may be used as the core 120 or the core 220. FIG. 3B is a cross-sectional view of the core 320. FIG. 3C is a top view of the core 320.

The magnetic core 320 may be made from any magnetic material. In some implementations, the magnetic core 320 is made from a magnetic material that is initially in particulate form. Examples of particulate forms include, without limitation, powders, shards, dust, microspheres, particles, fragments, shavings, or a combination of such items. In the initial state, the items within the particulate form can generally move relative to each other. For example, when in its initial form, some of the particulate matter may be easily separated from the remainder of the particular matter. However, the particulate form is capable of being processed into a three-dimensional object with a stable shape, such as the core 320. For example, the particulate magnetic material may be processed into the single-piece core 320 by pressing or compacting a quantity of the particulate magnetic material together, put into a solution, mixed with an adhesive such an epoxy, molded or pressed, and/or baked. Although the items of the particulate magnetic material are held together in a permanent or semi-permanent manner once processed, void space can remain between some or all the items of the magnetic material. The void spaces are filled with air, which lowers the magnetic permittivity of the core 320 as compared to a similarly rated magnetic core made out of solid iron or other solid magnetic material. Moreover, the presence of the void spaces can take the place of an intentional large volume air gap that is present in traditional iron cores. Due to being able to avoid the intentional large volume air gap, the use of the particulate material allows the core 320 to be smaller than a similarly rated core made of a solid magnetic material. Specific examples of materials that can be used for the magnetic core 320 include, without limitation, magnetic alloy powder materials, magnetic iron powder materials, iron and silicon, iron and nickel, or any other magnetic materials. Although forming the core 320 from a particulate magnetic material can provide performance enhancements, the core 320 may be made from a solid magnetic material. For example, the core 320 may be cast into a single-piece iron object.

FIGS. 3A-3C show the magnetic core 320 in processed form. The magnetic core 320 has two through holes 324a and 324b on either side of a center post 325 and a hollow cut 327 in a top portion 321 of the core 320 above the center post 325. The cross section of the magnetic core 320 in the X-Y plane has a substantially E shape. In the example shown, the magnetic core 320 has recessed areas 323a and 323b at the bottom side 322 of the through holes 324a and 324b, respectively. The recessed areas 323a and 323b are sized to accommodate winding terminals (such as the terminal pads 131a and 131b shown in FIGS. 1A and 1B). However, the recessed areas 323a and 323b are optional and some implementations of the magnetic core 320 lack the recessed areas 323a and 323b.

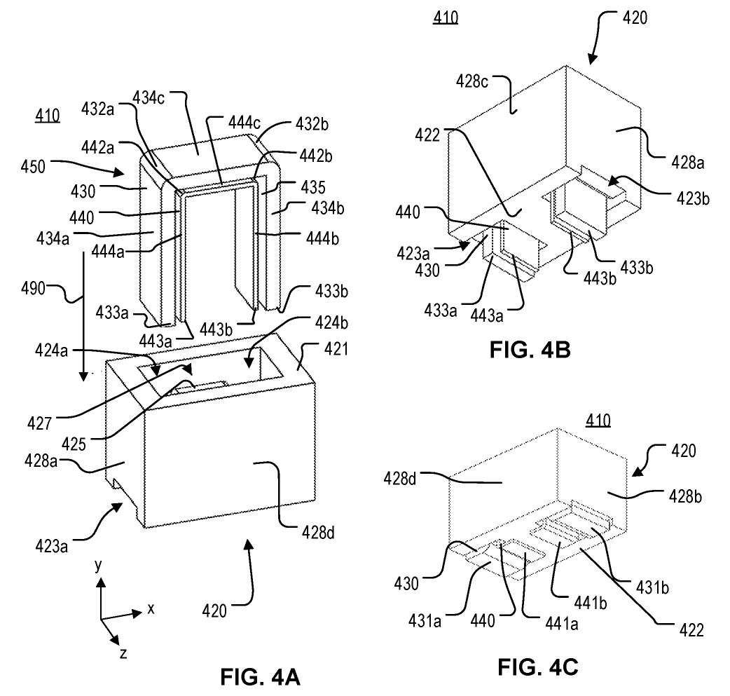

FIG. 4A is an exploded view of another example of a single-piece core trans-inductor 410. FIGS. 4B and 4C are perspective views of the trans-inductor 410 assembled.

The single-piece core trans-inductor 410 includes a magnetic core 420 and a winding assembly 450. The magnetic core 420 includes sides 428a, 428b, 428c, and 428d that extend between a top portion 421 and a bottom portion 422 (FIGS. 4B and 4C) to form a three-dimensional object. The sides 428a and 428b are parallel to each other and the sides 428c and 428d are parallel to each other. The core 420 also includes a central post 425 in the interior such that the core 420 has a substantially E-shaped cross-section. The top portion 421 defines an open region 427 and there are through holes 424a and 424b on either side of the central post 425. Together, the open region 427 and the through holes 424a and 424b define an open space in the core 420. The sides 428a and 428b each define a respective recessed area 423a and 423b near the bottom portion 422.

The winding assembly 450 includes an inner winding 440 and an outer winding 430. The winding assembly 450 is substantially U-shaped, with side portions 444a and 444b of the inner winding 440 connecting to a top portion 444c that extends between the side portions 444a and 444b at curved interface portions 442a and 442b and side portions 434a and 434b of the outer winding 430 connecting to a top portion 434c that extends between the side portions 434a and 434b at curved interface portions 432a and 432b. The inner winding 440 extends from a first end 443a to a second end 443b and the outer winding 430 extends from a first end 433a to a second end 433b.

To assemble the winding assembly 450, the inner winding 440 and the outer winding 430 are formed into a shape that can fit into the open space in the interior of the single-piece core 420. For example, sheets or bars of an electrically conductive material can be bent or folded into U-shaped or C-shaped windings. In some implementations, the windings 430 and 440 are stamped or laser cut into U-shaped or C-shaped elements from larger pieces of electrically conductive material.

The inner winding 440 and the outer winding 430 are separated by a gap 435 and are electrically isolated from each other. For example, the gap 435 may be filled with an electrically insulating material. The inner winding 440 is partially surrounded by the outer winding 430, and the winding assembly 450 has mirror symmetry about the X axis, the Y axis, and the Z axis. Other implementations are possible. For example, the inner winding 440 may be displaced in the Z direction such that the winding assembly 450 does not have mirror symmetry about the X and Z axes.

The winding assembly 450 may be a pre-formed rigid body. For example, the electrically insulating material in the gap 435 may physically hold the windings 430 and 440 together in a fixed spatial relationship as a pre-formed component sized to fit into the open space in the interior of the core 420. In some implementations, the windings 430 and 440 are placed in a mold and the electrically insulating material is injected into the mold to form a rigid assembly that electrically isolates the windings 430, 440 from each other. The pre-formed rigid winding assembly 450 can be easily dropped into the open region 427 to assemble the trans-inductor 410.

To assemble the single-piece core trans-inductor 410, the winding assembly 450 is inserted into the core 420 along the direction indicated by the arrow 490 (FIG. 4A). Specifically, the ends 433a and 433b of the outer winding 430 and the ends 443a and 443b of the inner winding 440 are inserted into the open region 427 and then the winding assembly 450 is pressed along the direction indicated by the arrow 490 until the ends 433a, 433b and 443a, 443b extend from the bottom portion 422 of the core 420. When the winding assembly 450 is fully inserted into the core 420, the side portions 434a, 444a are positioned in the through hole 424a, the side portions 434b, 444b are positioned in the through hole 424b, and the top portions 434c, 444c are positioned in the open region 427. The ends 433a, 433b, 443a, 443b extend to the exterior of the core 420.

Referring also to FIG. 4C, the ends 433a, 433b, 443a, and 443b may be bent to create respective terminal pads 431a, 431b, 441a, and 441b. To create terminal pads 431a and 431b, the ends 433a and 433b are bent away from each other and into the recessed areas 423a and 423b, respectively. Similarly, to create terminal pads 441a and 441b, the ends 443a and 443b are bent toward each other. In FIG. 4C, the terminal pads 441a, 441b, 431a, and 431b are substantially coplanar, which may facilitate electrical connection of the terminal pads to a PCB.

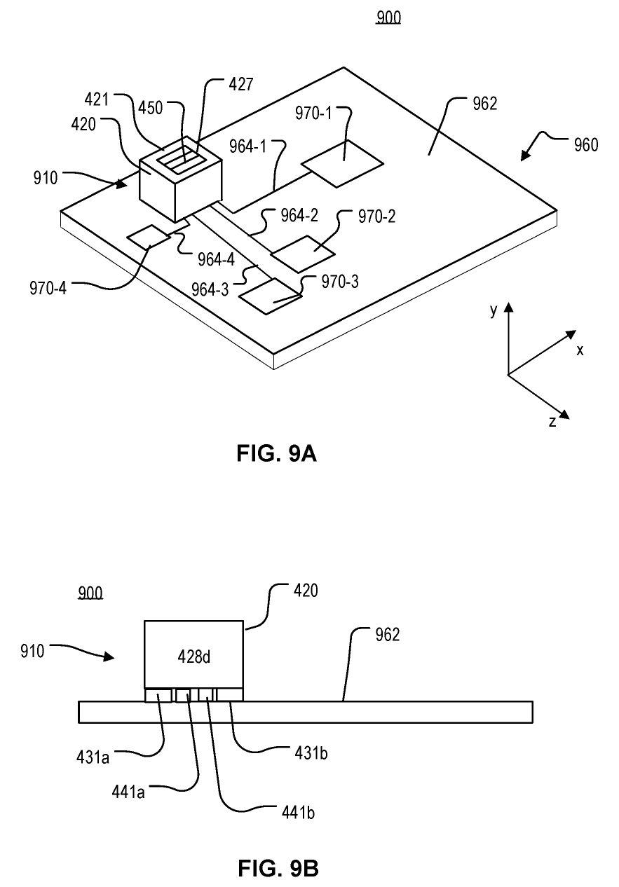

Referring also to FIG. 9A, which is a perspective view of a system 900 that includes the assembled trans-inductor 410 shown in FIG. 4C and a PCB 960, the single-piece core trans-inductor 410 is electrically connected to trace(s) on the PCB 960. FIG. 9B is a side view of the system 900. The PCB 960 is a laminated structure of electrically conductive and electrically insulating layers and an electrically insulating surface 962. Electrically conductive traces 964-1, 964-2, 964-3, 964-4 are formed on the surface 962 by, for example, etching. The PCB 960 also includes components 970-1, 970-2, 970-3, 970-4 on the surface 962. The components 970-1, 970-2, 970-3, 970-4 are any type of electronic component or a device (for example, a socket) configured to connect to an electronic component.

The electrically conductive traces 964-1, 964-2, 964-3, 964-4 are made of a material such as copper. In the example shown, the inner winding 540 is electrically connected to the conductive traces 964-2 and 964-3, and the outer winding 530 is electrically connected to the conductive traces 964-1 and 964-4. Specifically, the terminal pads 431a, 431b are electrically connected to the conductive traces 964-4, 964-1, respectively, and the terminal pads 441a, 441b are connected to the traces 964-3, 964-2, respectively.

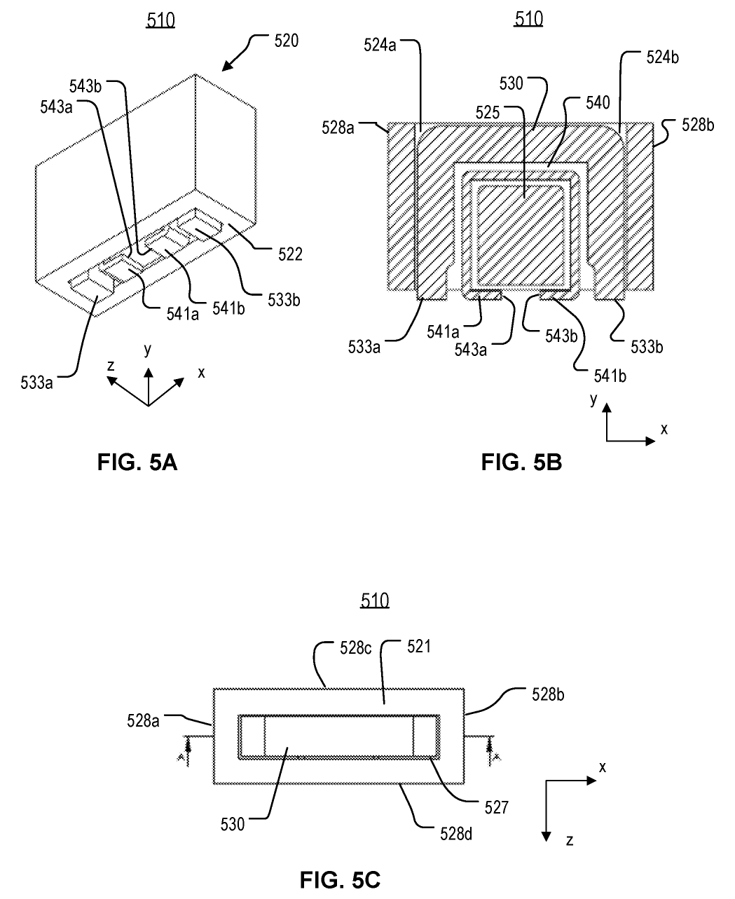

FIG. 5A is a perspective view of another example single-piece trans-inductor 510. FIG. 5B is a cross-sectional view of the trans-inductor 510. FIG. 5C is a top view of the trans-inductor 510.

The trans-inductor 510 includes a single-piece magnetic core 520, an inner winding 540, and an outer winding 530. The core 520 includes sides 528a, 528b, 528c, and 528d that extend between a top portion 521 and a bottom portion 522 to form a three-dimensional object. The sides 528a and 528b are parallel to each other and the sides 528c and 528d are parallel to each other. The core 520 also includes a central post 525 in the interior such that the core 520 has a substantially E-shaped cross-section. The top region 521 defines an open region 527 and there are through holes 524a and 524b on either side of the central post 525. Together, the open region 527 and the through holes 524a and 524b define an open space in the core 520.

The inner winding 540 and the outer winding 530 are U-shaped windings that are received in the open space in the core 520 and partially surround the central post 525. Ends 533a and 533b of the outer winding 530 and ends 543a and 543b of the inner winding 540 extend through the bottom portion 522 to the exterior of the core 520. As shown, in the trans-inductor 510, the ends 543a and 543b of the inner winding 540 are bent into respective terminal pads 541a and 541b. The ends 533a and 533b of the outer winding 530 are not bent and are intended to act as terminals. In other words, the ends 533a and 533b are configured to be electrically connected to a trace or electrical interface on a PCB. This configuration with only the inner winding 540 having a bent portion to form terminal pads may be suitable for applications requiring low resistance in the primary winding (the outer winding 530). The terminal pads 541a, 541b of the inner winding 540 and the ends and the ends 533a and 533b of the outer winding 530 may have a substantially same coplanarity. To assemble the trans-inductor 510, the windings 530 and 540 may be inserted into the holes of the magnetic core and bending the inner winding terminals.

In other implementations, the ends 533a and 533b of the outer winding 530 are bent to form terminal pads and the inner winding 540 is not bent at the ends 543a and 543b. In these implementations, the terminal pads formed by bending the ends 533a and 533b of the outer winding 530 and the un-bent ends 543a and 543b of the inner winding 540 may have a substantially same coplanarity.

In yet another configuration, none of the ends 533a, 533b, 543a, 543b are bent. In these implementations, the the un-bent ends of the inner winding 540 form terminals and the un-bend ends of the outer winding 530 form terminals, and all of these terminals may have substantially same coplanarity.

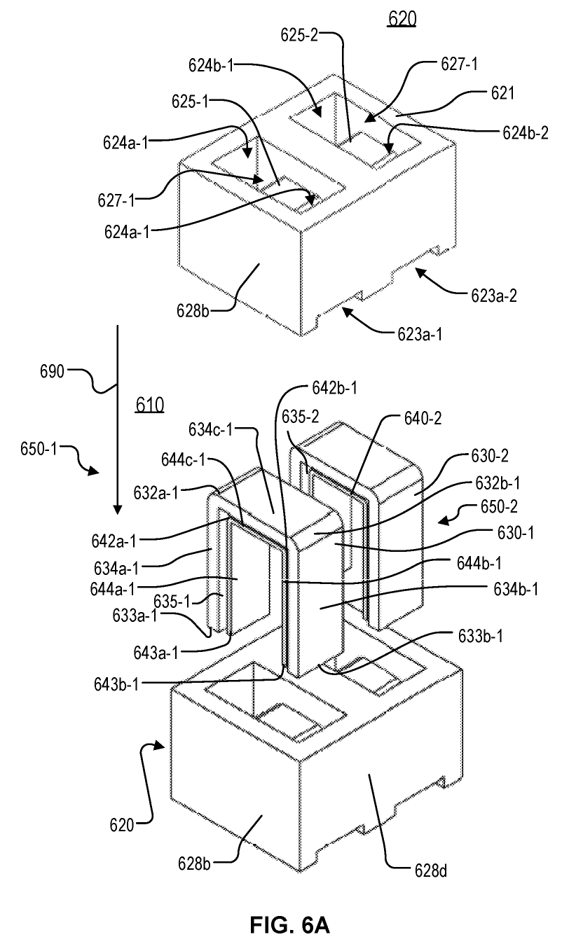

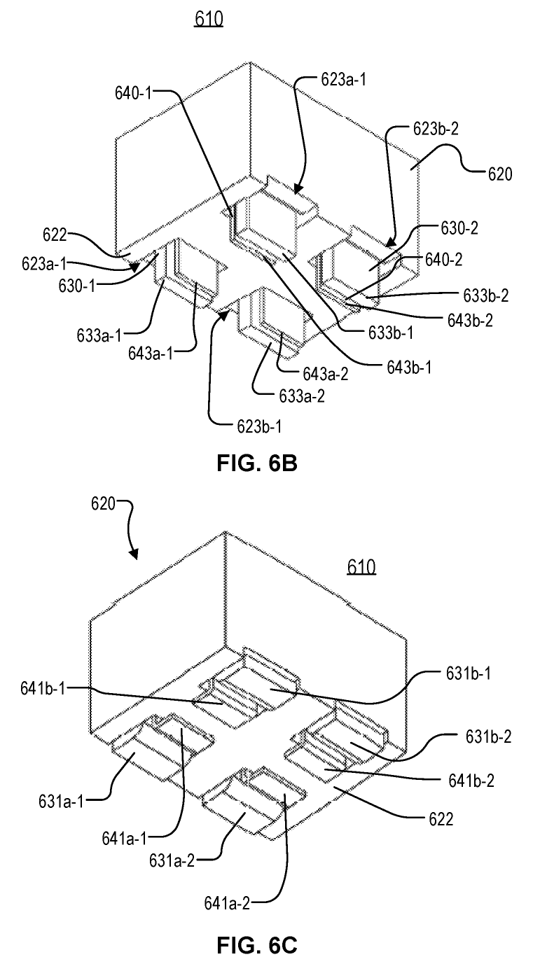

The examples above relate to single-phase trans-inductors, but the single-piece core trans-inductor may be multi-phase. For example, the single-piece core trans-inducer may be implemented with two phases or more than two phases. As discussed below, in multi-phase implementations, there are is a separate inductor (or winding assembly) for each phase, and all of the winding assemblies share one single-piece magnetic core. For example, a two‑phase implementation (such as shown in FIGS. 6A-6D includes a single-piece magnetic core 620 and two winding assemblies 650-1 and 650-2 that share the core 620. In multi-phase implementations, each phase has a dedicated winding assembly that includes an inner winding and outer winding. Within each phase, the inner and outer windings are electrically isolated from one another, for example by an insulating layer or spacing, as discussed above with respect to the winding assembly 450. In the multi‑phase implementations, the trans-inductor therefore includes a winding assembly for each phase, and each winding assembly includes an inner winding and outer winding. The winding assemblies are physically separated from one another by portions of the single‑piece core. In other words, no winding assembly makes direct physical contact with the winding assembly of another phase.

The single-piece magnetic core may be formed from a powder‑based magnetic material. As discussed above, powder‑based magnetic materials have void space between particles and thus exhibit a degree of electrical insulation between particles, which can provide sufficient phase-to-phase electrical isolation between the various winding assemblies in multi-phase implementations for low‑voltage operation. For applications with higher operating voltages, the core can be coated with an additional insulating material to enhance the phase-to-phase separation and phase-to-phase electrical isolation between the various winding assemblies. Additionally, there is phase-to-phase magnetic isolation or near magnetic isolation among the phases. For example, the coupling coefficient between windings of one phase and the windings of another phase may be, for example, 0.1 or lower, 0.2 or lower, or 0.3 or lower. In other words, in use, the windings of the winding assembly of one phase may be substantially magnetically isolated from the windings of all of the other phases.

The operating voltages for both the single‑phase and multi‑phase trans‑inductors described in the application are relatively low, such that the described isolation mechanisms are sufficient for intended operation. For example, the application voltage for the single-piece core trans-inductor may be from 12VDC to about 1VDC

FIG. 6A is an exploded view of an example configuration of a two-phase single-piece core trans-inductor 610. FIGS. 6B and 6C are perspective views of the trans-inductor 610 assembled.

The two-phase single-piece core trans-inductor 610 includes a magnetic core 620 and a winding assembly for each phase, specifically, the trans-inductor 610 includes a first winding assembly 650-1 and a second winding assembly 650-2.

The magnetic core 620 is a single-piece core that includes sides 628a, 628b, 628c, and 628d that extend between a top region 621 and a bottom portion 622 (FIGS. 6B and 6C) to form a three-dimensional object. The sides 628a and 628b are parallel to each other and the sides 628c and 628d are parallel to each other. The core 620 also includes a central post 625 in the interior. The top region 621 defines open regions 627-1 and 627-2. Through holes 624a-1 and 624b-1 extend from the open region 627-1 on either side of the central post 625. Through holes 624a-2 and 624b-2 extend from the open region 627-2 on either side of the central post 625. Together, the open region 627-1 and the through holes 624a-1 and 624b-1 define a first phase open space in the core 620. The open region 627-2 and the through holes 624a-2 and 624b-2 define a second phase open space in the core 620. The side 628a defines recessed areas 623a-1 and 623a-2, and the side 628b defines recessed areas 623b-1 and 623b-2 near the bottom portion 622.

The winding assembly 650-1 includes an inner winding 640-1 and an outer winding 630-1 that are separated by a gap 635-1. The gap 635-1 electrically isolates the windings 630-1 and 640-1 from each other. The gap 635-1 may be filled with an electrically insulating material that also provides structural support to the winding assembly 650-1. For example, the gap 635-1 may be filled with a molded plastic material. Although the windings 630-1 and 640-1 are electrically isolated, they can be magnetically coupled to each other. The winding assembly 650-1 is substantially U-shaped, with side portions 644a-1 and 644b-1 of the inner winding 640-1 connecting to a top portion 644c-1 that extends between the side portions 644a-1 and 644b-2 at curved interface portions 642a-1 and 642b-1 and side portions 634a-1 and 634b-1 of the outer winding 630-1 connecting to a top portion 634c-2 that extends between the side portions 634a-1 and 634b-1 at curved interface portions 632a-1 and 632b-2. The inner winding 640-1 extends from a first end 643a-1 to a second end 643b-1 and the outer winding 630-1 extends from a first end 633a -1 to a second end 633b-1.

The second winding assembly 650-2 is similarly configured. Moreover, each of the winding assemblies 650-1 and 650-2 may be similar to the winding assembly 450 and may be pre-prepared prior to integration into the core 620 as discussed above. Pre-preparing or pre-assembling the winding assemblies 650-1 and 650-2 allows the winding-to-winding insulation within each phase (intra-phase) to be defined prior to assembly with the core 620. For example, the characteristics of respective gaps 635-1 and 635-2 be controlled and defined prior to assembly with the core 620. For example, the gaps 635-1 and 635-2 may be defined as a certain size and/or filled with an electrically insulating material prior to assembly with the core 620.

Beyond the intra-phase electrical insulation, the trans-inductor 610 also includes phase-to-phase electrical isolation. The phase-to-phase or inter-phase electrical isolation may be facilitated by pre-preparing or pre-forming the winding assemblies 650-1 and 650-2. For example, each winding assembly 650-1 and 650-2 can be assembles with its inner winding and outer winding held in a fixed spatial relationship by an insulating structure. As a result, winding-to-winding and phase-to-phase electrical insulation can be established and controlled prior to insertion into the magnetic core 620.

The approach of pre-preparing or preforming the winding assemblies 650-1 and 650-2 prior to insertion into the core 620 provides manufacturing advantages compared to other techniques for producing multi-phase trans-inductors. For example, one existing approach for producing a multi-phase trans-inductor involves an over molding processes in which multiple windings (for example, four windings for a two-phase device) are loaded into mold cavities, pressed together, and cured. In such an over molding processes, the windings may shift or move during molding, and subsequent processing steps (such as stripping insulation from multiple terminals and tin plating) can degrade insulation resistance both between inner and outer windings and between different winding sets.

On the other hand, pre-formed winding assemblies 650-1 and 650-2 do not employ such post molding processing steps. Moreover, the winding assemblies 650-1 and 650-2 can be insulated before being combined with the core 620, reducing the risk of winding displacement and insulation resistance degradation and helping to preserve electrical insulation integrity.

In greater detail, to assemble the two-phase single-piece core trans-inductor 610, the winding assembly 650-1 is inserted into the core 620 along the direction indicated by the arrow 690 (FIG. 6A). Specifically, ends 633a-1 and 633b-1 of the outer winding 630-1 and the ends 643a-1 and 643b-1 of the inner winding 640-1 are inserted into the open region 627-1 and then the winding assembly 650-1 is pressed along the direction indicated by the arrow 690 until the ends 633a-1, 633b-1 and 643a-1, 643b-2 extend from the bottom portion 622 of the core 620. When the winding assembly 650-1 is fully inserted into the core 620, the side portions 634a-1, 644a-1 are positioned in the through hole 624a-1, the side portions 634b-1, 644b-1 are positioned in the through hole 624b-1, and the top portions 634c-1, 644c-1 are positioned in the open region 627-1. The ends 633a-1, 633b-1, 643a-1, 643b-1 extend to the exterior of the core 620.

Referring also to FIG. 6C, the ends 633a-1, 633b-1, 643a-1, and 643b-1 may be bent to create respective terminal pads 631a-1, 631b-1, 641a-1, and 641b-1. To create terminal pads 631a-1 and 631b-1, the ends 633a-1 and 633b-1 are bent away from each other and into the recessed areas 623a-1 and 623b-1, respectively. Similarly, to create terminal pads 641a-1 and 641b-1, the ends 643a-1 and 643b-1 are bent toward each other. In FIG. 6C, the terminal pads 641a-1, 641b-1, 631a-1, and 631b-1 are substantially coplanar, which may facilitate electrical connection of the terminal pads to a PCB. To electrically connect the single-piece core trans-inductor 610 to trace(s) on a PCB, the terminal pads 631a-1, 631b-1, 641a-1, and 641b-1 are connected to the trace(s).

The winding assembly 650-2 is inserted into the open region 627-2 and similarly integrated into the core 620. The winding assemblies 650-1 and 650-2 may be inserted into the respective openings 627-1 and 627-2 at the same time or at different times.

The integrated two-phase trans-inductor architecture of the trans-inductor 610 employs one single-piece magnetic core 620 and two pre-formed winding assemblies 650-1 and 650-2, which makes the assembly and alignment much easier and much more robust. As discussed above, the assembly process may include inserting each of the two pre-formed winding assemblies 650-1 and 650-2 into the respective open spaces in the single-piece core and bending the inner windings’ terminals and outer windings’ terminals so that the inner windings’ terminals and outer windings’ terminals have a substantially same coplanarity.

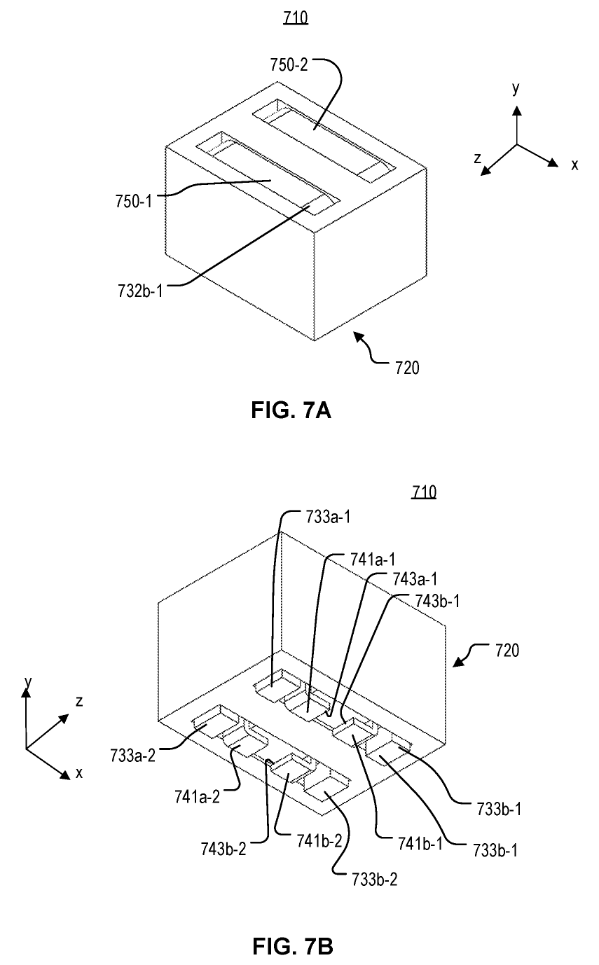

FIG. 7A is a perspective view of another example configuration of a two-phase single-piece magnetic core trans-inductor 710. FIG. 7B illustrates a bottom view of the trans-inductor 710. The single-piece core trans-inductor 710 includes a magnetic core 720 and winding assemblies 750-1 and 750-2. The trans-inductor 710 is similar to the trans-inductor 610 (FIGS. 6A-6C) except, in the trans-inductor 710, only ends 743a-1, 743b-1, 743a-2, 743b-2 of an inner winding are bent into terminal pads 713a-1, 741b-1, 741a-2, 741b-2. The terminal pads 741a-1, 741b-1, 741a-2, 741b-2 of the inner windings and ends 733a-1, 733b-1, 733a-2, 733b-2 of the outer windings may have a substantially same coplanarity. The assembly process may include inserting the two winding sets into the two through hole sets of the single-piece core and bending the inner windings’ terminals so that the inner windings’ terminals and outer windings’ terminals have a substantially same coplanarity.

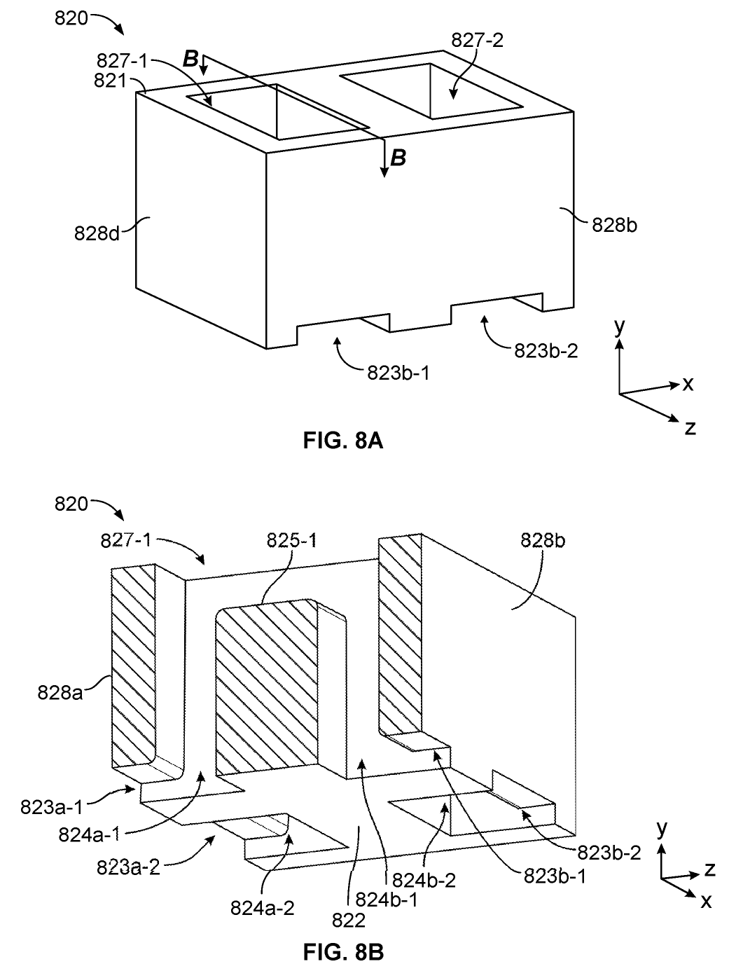

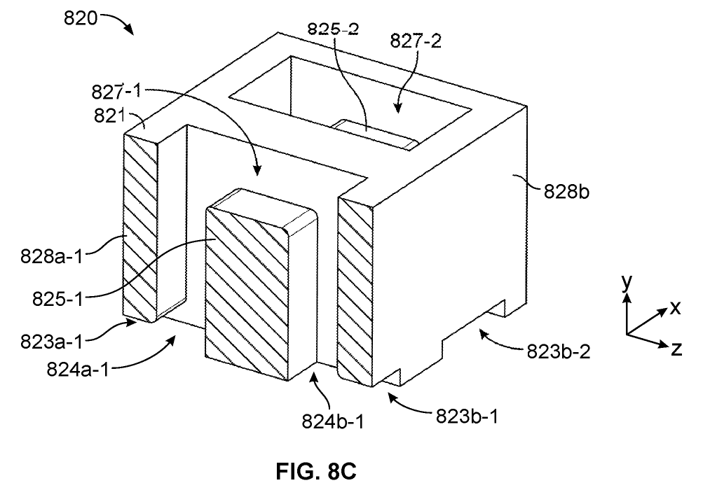

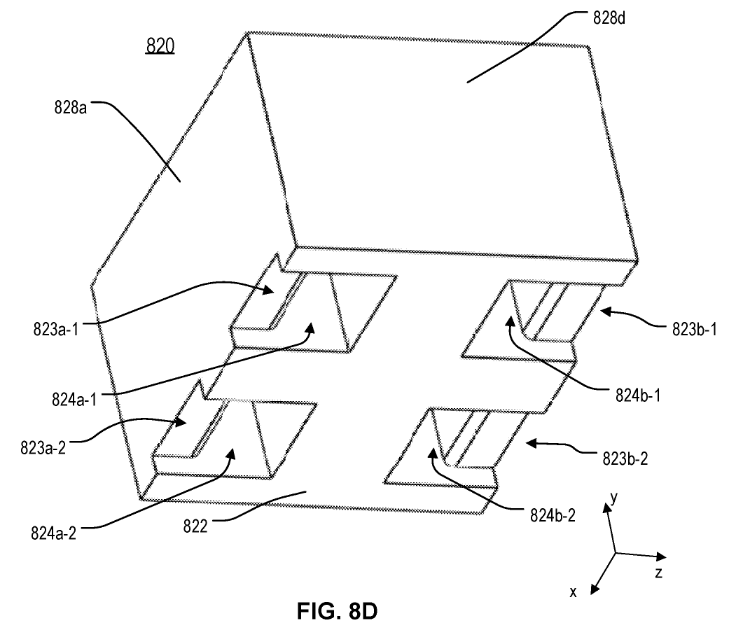

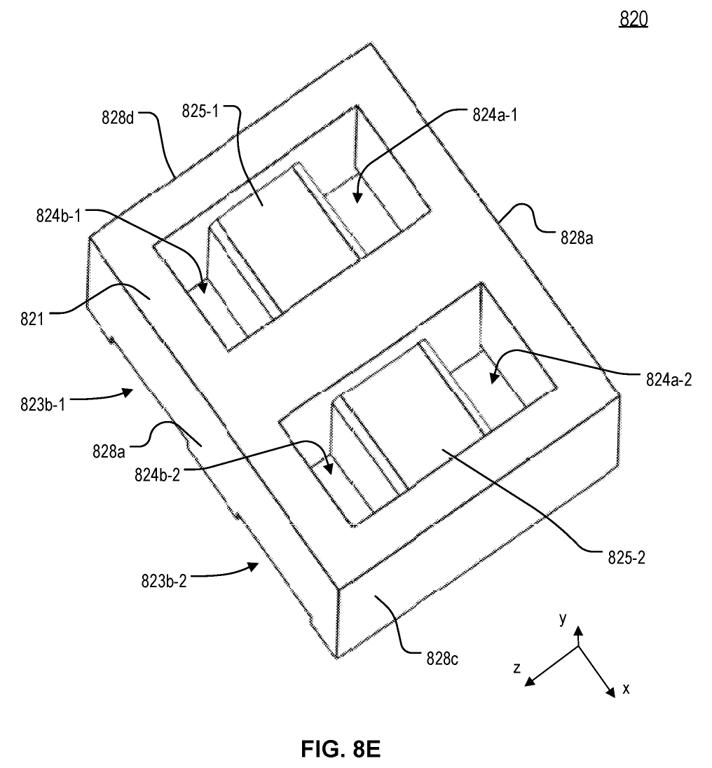

FIG. 8A is a perspective view of an example two-phase single-piece magnetic core 820. The core 820 may be used as the core 620 or the core 720. FIG. 8B illustrates a cross-sectional view of the example two-phase single-piece core 820. FIG. 8C illustrates another cross-sectional view of the example two-phase single-piece core 820. FIG. 8D illustrates a bottom view of the example two-phase single-piece core 820. FIG. 8E illustrates a top view of the example two- phase single-piece core 820.

The magnetic core 820 includes sides 828a, 828b, 828c, and 828d that extend between a top portion 821 and a bottom portion 822 (FIGS. 8B and 8C) to form a three-dimensional object. The sides 828a and 828b are parallel to each other and the sides 828c and 828d are parallel to each other. The core 820 also includes central posts 825-1 and 825-2 in the interior. The central posts 825-1 and 825-2 are integral with the core 820 and the core 820 is a single, unitary piece. The top portion 821 defines open regions 827-1 and 827-2. Through holes 824a-1 and 824b-1 extend from the open region 827-1 on either side of the central post 825-1 to form a first open space in the core 420. The first open space is configured to receive a winding assembly for one phase, such as the winding assembly 450. Through holes 824a-2 and 824b-2 extend from the open region 827-2 on either side of the central post 825-2 to define a second phase open space in the core 820. The second open space is configured to receive a winding assembly for one phase, such as the winding assembly 450. Thus, the core 820 is configured to receive two winding assemblies, one for each phase, and is a two-phase single-piece core.

The side 828a defines two recessed areas 823a-1 and 823a-2 at the bottom portion 822, and the side 828b defines recessed areas 823b-1 and 823b-2 at the bottom portion 822. The recessed areas 823a-1 and 823b-1 accommodate bent end regions of the windings of the first phase winding assembly and the recessed area 823a-2 and 823b-2 accommodate bent end regions of the second phase winding assembly.

As described herein, the disclosed single-phase single-piece core trans-inductor may employ three components: one single-piece magnetic core and two windings (an inner winding and an outer winding). The two windings can further be integrated to an integrated winding assembly. The integrated winding assembly may be pre-formed or pre-prepared and inserted into the single-piece magnetic core, as discussed above. The trans-inductor may be implemented as a multi-phase component. In the multi-phase implementation, the trans-inductor employs more than three components: one single-piece magnetic core and two windings (an inner winding and an outer winding) for each of the multiple phases. The inner and outer windings of each phase may be integrated into a pre-formed winding assembly. In the pre-formed winding assembly, the inner and outer windings are electrically isolated from each other but can be magnetically coupled. The pre-formed winding assemblies are inserted into the single-piece magnetic core, as discussed above. Once inserted into the single-piece magnetic core, the winding assemblies are electrically isolated from each other and are not magnetically coupled with each other, or are only weakly magnetically coupled with each other.

Alloy powder magnetic material can be used to make such single-piece magnetic core. As compared to a core made of a solid magnetic material, such as solid ferrite, a single-piece alloy powder core can provide a required inductance, a better saturation current, as well as a better power conversion efficiency. Furthermore, as compared to a core made of a solid magnetic material, the disclosed trans-inductor can have smaller footprint to save PCB real estate since one can use alloy powder magnetic material to make the core and alloy powder magnetic material has much higher flux density comparing to typical trans-inductor’s ferrite cores. No epoxy is needed to glue the core halves since the core is a single-piece solid core. Therefore, there are no core separation issues and core misalignment issues. The disclosed single-piece core trans-inductor offers higher saturation current capability and better performance under high currents compared to solid ferrite material, making it suitable for high-power applications.

Some traditional approaches may be able to use metal powder material to manufacture the trans-inductor by integrating winding and powder pressing into a single step. The pressing method may include placing the winding inside a cavity, adding press powder material into the cavity, pressing the entire assembly together under high pressure, and having the pressed component undergo annealing at high temperatures. After annealing, the product is complete without any manual assembly. However, compared to the disclosed single-piece core trans-inductor, the traditional pressing method has several disadvantages including low yield rate, quality issues, high-temperature annealing risks, material fragility, and process limitations.

The technical advantages of the disclosed single-piece core trans-inductor may include more stable permeability (for example, improved magnetic flux handling due to the absence of air gaps), better saturation capability (for example, can handle higher currents without significant drop in inductance), and manufacturing efficiency (for example, simplified manufacturing process with reduced risk of epoxy bonding failures).

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example implementations described or illustrated herein that a person having ordinary skill in the art would comprehend. The scope of this disclosure is not limited to the example implementations described or illustrated herein. Moreover, although this disclosure describes and illustrates respective implementations herein as including particular components, elements, feature, functions, operations, or steps, any of these implementations may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular implementations as providing particular advantages, particular implantations may provide none, some, or all of these advantages.

The above implementations and examples and other examples are within the scope of the claims. For example, any of the single-piece cores 120, 220, 320, 420, 520, 620, 720, 820 may be made of a magnetic material that is initially in particulate form. In another example, the cores 620, 720, 820 are configured for two-phase applications and to receive two winding assemblies, one for each phase. However, any of the cores 620, 720, 820 may be configured as N-phase single-piece cores, where N is an integer number greater than two. Moreover, although the trans-inductor 410 is shown on the PCB 960 in FIGS. 9A and 9B, any of the trans-inductors discussed herein may be utilized as a surface-mount electronic component and may be electrically connected to the PCB 960 or another PCB.

What is claimed is:

1. A surface mount electromagnetic component for multi-phase electrical power circuitry implemented on a circuit board, the component comprising:
a single-piece magnetic core structure; and
a winding assembly for each phase, each winding assembly comprising:
an inner winding and an outer winding,
wherein the inner winding is electrically isolated from the outer winding,
wherein the inner winding defines a first inverted U-shaped main winding portion, wherein the first inverted U-shaped main winding portion includes a first top section and first vertical legs perpendicular to the first top section, and
wherein the outer winding defines a second inverted U-shaped main winding portion, wherein the second inverted U-shaped main winding portion includes a second top section and second vertical legs perpendicular to the second top section.

2. The electromagnetic component of claim 1, wherein the single-piece magnetic core structure is made from metal powder material.

3. The electromagnetic component of claim 1, wherein the single-piece magnetic core structure is made from ferrite material.

4. An electromagnetic component comprising:
a single-piece magnetic core structure;
one or more winding assemblies, each winding assembly configured to be received in a respective open space in the single-piece magnetic core structure, and each winding assembly comprising:
a first electrically conductive winding; and
a second electrically conductive winding, wherein the second electrically conductive winding is electrically isolated from the first electrically conductive winding and is configured to be magnetically coupled to the first electrically conductive winding, and wherein each winding assembly is electrically isolated from any other winding assembly.

5. The electromagnetic component of claim 4, wherein the single-piece magnetic core structure is made of a particulate magnetic material.

6. The electromagnetic component of claim 4, wherein each of the first and second electrically conductive windings of each winding assembly comprises a top portion and first and second leg portions that extend from the top portion.

7. The electromagnetic component of claim 6, wherein ends of each of the first and second leg portions of the first and second electrically conductive windings extend to an exterior of the single-piece magnetic core structure.

8. The electromagnetic component of claim 7, wherein an end of one or more of the first and second leg portions of the first and second electrically conductive windings are bent into terminal pads.

9. The electromagnetic component of claim 4, wherein, in each winding assembly, the second electrically conductive winding is at least partially surrounded by the first electrically conductive winding.

10. The electromagnetic component of claim 4, wherein, in each winding assembly, the second electrically conductive winding and the first electrically conductive winding are arranged such that the winding assembly is asymmetrical in at least one dimension.

11. The electromagnetic component of claim 4, wherein, in each winding assembly, the second electrically conductive winding and the first electrically conductive winding are arranged such that the winding assembly has mirror symmetry in at least two dimensions.

12. The electromagnetic component of claim 4, wherein each winding assembly further comprises an electrically insulating material between the first electrically conductive winding and the second electrically conductive winding.

13. The electromagnetic component of claim 12, wherein, in each winding assembly, the electrically insulating material holds the first electrically conductive winding and the second electrically conductive winding in a fixed spatial relationship.

14. The electromagnetic component of claim 4, wherein the single-piece magnetic core structure further comprises a sidewall structure extending between a top portion and a bottom portion, the top portion defining an open space for each of the one or more winding assemblies, and the bottom portion defines two openings for each of the one or more winding assemblies.

15. The electromagnetic component of claim 14, wherein the sidewall structure comprises four sidewalls, each sidewall perpendicular to two other sidewalls and parallel to one other sidewall, and wherein two of the four sidewalls define at least one recessed region near the bottom portion.

16. The electromagnetic component of claim 4, wherein the single-piece magnetic core structure further comprises a sidewall structure extending between a top portion and a bottom portion, the top portion defines an opening to a respective open space, and the bottom portion defines openings to a respective open space.

17. The electromagnetic component of claim 4, wherein each winding assembly is pre-formed separately from the single-piece magnetic core structure.

18. An assembly comprising:
a first electrically conductive winding comprising a first top portion and two first legs extending from the first top portion;
a second electrically conductive winding comprising a second top portion and two second legs extending from the second top portion, and
an electrically insulating material between the first and second electrically conductive windings, wherein the second electrically conductive winding is electrically isolated from the first electrically conductive winding and is configured to be magnetically coupled to the first electrically conductive winding, the electrically insulating material holds the first and second electrically conductive windings in a fixed spatial relationship, and the assembly is pre-prepared and configured for insertion into an opening in a single-piece magnetic core.

19. A method of assembling an electromagnetic component for multi-phase electrical power circuitry, the method comprising:
providing a single-piece magnetic core comprising a center post and a top portion that defines one or more open regions, each open region associated with one phase and leading to a respective open space in the single-piece magnetic core, each open space comprising an open region above the center post and though holes on at least two sides of the center post;
providing one or more pre-formed winding assemblies, wherein each winding assembly associated with one phase and comprising first and second U-shaped electrically conductive windings that are electrically isolated from each other and held in a fixed spatial relationship; and
assembling the electromagnetic component for multi-phase electrical power circuitry by inserting each of the pre-formed winding assemblies into a respective one of the one or more open regions with legs of the first and second U-shaped electrically conductive windings extending to the exterior of the single-piece magnetic core.

20. The method of claim 19, wherein assembling the electromagnetic component for multi-phase electrical power circuitry further comprises bending an end of one or more of the first and second U-shaped electrically conductive winding to form a terminal pad.

21. The method of claim 19, further comprising electrically connecting the each of the first and second U-shaped electrically conductive windings to one or more traces on a printed circuit board.
